(19) United States
(12) Patent Application Publication
(10) Pub. No.: US 2011/0067678 A1
(43) Pub. Date: Mar. 24, 2011

(54) METHOD AND DEVICE FOR OPERATING AN INTERNAL COMBUSTION ENGINE AND AN INTERNAL COMBUSTION ENGINE

(76) Inventors: Thomas Burkhardt, Neutraubling (DE); Andreas Hofmann, Falkenfels (DE); Gerhard Schopp, Pettendorf (DE)

(21) Appl. No.: 12/994,080

(22) PCT Filed: May 25, 2009
(86) PCT No.: PCT/EP09/56287

§ 371 Date: Nov. 22, 2010

(30) Foreign Application Priority Data
May 28, 2008 (DE) 10 2008 025 549.1

(51) Int. Cl. F02B 33/00; F02D 41/00

(52) U.S. Cl. 123/559.1; 701/102

(57) ABSTRACT

An internal combustion engine has an air intake system with an air intake pipe and which communicates with a combustion chamber of a cylinder as a function of a switch position of a gas inlet valve. Furthermore, a compressor is disposed in the air intake system and is embodied for the purpose of compressing a mass air flow. Also, a throttle valve is disposed in the air intake system downstream of the compressor and by which the compressed mass air flow into the air intake pipe can be throttled. The internal combustion engine furthermore has a differential pressure sensor which is disposed in the air intake system and is embodied for the purpose of measuring a differential pressure between a charge pressure that prevails downstream of the compressor and upstream of the throttle valve and an ambient pressure that prevails outside of the air intake system.

### CROSS-REFERENCE TO RELATED APPLICATIONS

This application is a U.S. National Stage Application of International Application No. PCT/EP2009/056287 filed May 25, 2009, which designates the United States of America, and claims priority to German Application No. 10 2008 025 549.1 filed May 28, 2008, the contents of which are hereby incorporated by reference in their entirety.

### TECHNICAL FIELD

The invention relates to a method and a device for operating an internal combustion engine and to an internal combustion engine. The internal combustion engine comprises an air intake system which comprises an air intake pipe. The air intake system communicates with a combustion chamber of a cylinder of the internal combustion engine as a function of the switch position of a gas inlet valve. Disposed in the air intake system is a compressor which is embodied for compressing a mass air flow. Also disposed in the air intake system is a throttle valve by means of which the compressed mass air flow into the air intake pipe can be throttled.

### BACKGROUND

The turbocharger of an internal combustion engine typically comprises a compressor and a turbine which by preference are mechanically coupled to each other. In this arrangement the compressor is disposed in an air intake system of the internal combustion engine and compresses a mass air flow through the air intake system. The air compressed in this way flows via a gas inlet valve into the combustion chamber of the respective cylinder of the internal combustion engine. Preferably disposed at the cylinder head of the respective cylinder is an injection valve via which a predefined quantity of fuel can be fed into the combustion chamber. Following the combustion of the air/fuel mixture in the respective combustion chamber, an exhaust gas is discharged out of the combustion chamber via a gas outlet valve to an exhaust gas system in which the turbine of the turbocharger is disposed. The turbine is driven by means of the exhaust gases in such a way that the mass air flow through the air intake system is compressed by means of the compressor.

### SUMMARY

According to various embodiments, a method and a device for operating an internal combustion engine can be created which ensure that an ambient pressure can be determined in a simple and reliable manner. According to other embodiments, an internal combustion engine can be provided which can be manufactured particularly cost-effectively.

According to an embodiment, an internal combustion engine may comprise—an air intake system which comprises an air intake pipe and communicates with a combustion chamber of a cylinder of the internal combustion engine as a function of a switch position of a gas inlet valve, —a compressor which is disposed in the air intake system and is embodied for the purpose of compressing a mass air flow, —a throttle valve which is disposed in the air intake system downstream of the compressor and by means of which the compressed mass air flow of the compressor into the air intake pipe can be throttled, —a differential pressure sensor which is disposed in the air intake system and is embodied for the purpose of measuring a differential pressure between a charge pressure that prevails downstream of the compressor and upstream of the throttle valve and an ambient pressure that prevails outside of the air intake system.

According to a further embodiment, an ambient pressure sensor can be embodied for the purpose of measuring the ambient pressure.

According to another embodiment, a method for operating an internal combustion engine as described above may comprise the steps: the ambient pressure is determined as a function of the measured differential pressure between the charge pressure that prevails downstream of the compressor and upstream of the throttle valve and the ambient pressure that prevails outside of the air intake system.

According to a further embodiment of the method, the charge pressure can be determined and the ambient pressure can be determined as a function of the charge pressure. According to a further embodiment, an air intake pipe pressure that prevails downstream of the throttle valve and upstream of the gas inlet valve can be determined and the charge pressure can be determined as a function of the air intake pipe pressure.

According to a further embodiment, —a degree of opening of the throttle valve can be determined, —wherein the determined degree of opening of the throttle valve is compared with a predefined degree of opening of a characteristic throttle valve opening, the characteristic throttle valve opening being characterized in that at a degree of opening of the throttle valve which is greater than or equal to the degree of opening of the characteristic throttle valve opening a drop in pressure across the throttle valve remains essentially constant, —after the predefined degree of opening of the characteristic throttle valve opening has been reached, the drop in pressure across the throttle valve, which drop in pressure is associated with a degree of opening of the throttle valve which is greater than or equal to the characteristic throttle valve opening, is determined, —when the degree of opening of the characteristic throttle valve opening is reached, the charge pressure is determined as a function of the determined drop in pressure.

According to yet another embodiment, a device for operating an internal combustion engine as described above may be embodied for the purpose of determining the ambient pressure as a function of the measured differential pressure between the charge pressure that prevails downstream of the compressor and upstream of the throttle valve and the ambient pressure that prevails outside of the air intake system.

### BRIEF DESCRIPTION OF THE DRAWINGS

Exemplary embodiments are explained in more detail below with reference to the schematic drawings, in which:

FIG. 1 shows an internal combustion engine,

FIG. 2 shows various equations for determining an ambient pressure, and

FIG. 3 is a flowchart.

Elements of like construction or function are labeled by the same reference signs throughout the figures.

### DETAILED DESCRIPTION

According to a first aspect, an internal combustion engine may comprise an air intake system. The air intake system comprises an air intake pipe and communicates with a combustion chamber of a cylinder of the internal combustion engine as a function of a switch position of a gas inlet valve. The internal combustion engine further comprises a compressor which is disposed in the air intake system and is embodied for compressing a mass air flow. The internal combustion engine additionally comprises a throttle valve which is disposed in the air intake system downstream of the compressor and by means of which the compressed mass air flow of the compressor into the air intake pipe can be throttled. The internal combustion engine furthermore comprises a differential pressure sensor which is disposed in the air intake system and is embodied for the purpose of measuring a differential pressure between a charge pressure that prevails downstream of the compressor and upstream of the throttle valve and an ambient pressure that prevails outside of the air intake system. Using the differential pressure sensor enables the internal combustion engine to be manufactured particularly cost-effectively, in particular because further sensors for measuring an ambient pressure are preferably not required. The differential pressure between the charge pressure and the ambient pressure is measured by means of the differential pressure sensor. Thus, at a predefined ambient pressure the charge pressure can be determined particularly easily as a function of the differential pressure, and at a predefined charge pressure the ambient pressure can be determined particularly easily.

In an embodiment the internal combustion engine comprises an ambient pressure sensor which is embodied for the purpose of measuring the ambient pressure. This has the advantage that the determined ambient pressure can be validated for plausibility by means of the ambient pressure measured by the ambient pressure sensor which is preferably embodied as an absolute pressure sensor. Alternatively the ambient pressure measured by means of the ambient pressure sensor can also be validated for plausibility by means of the determined ambient pressure. This ensures particularly reliable operation of the internal combustion engine.

According to a second and third aspect, in a method and a corresponding device for operating an internal combustion engine, the ambient pressure is determined as a function of the measured differential pressure between the charge pressure that prevails downstream of the compressor and upstream of the throttle valve and the ambient pressure that prevails outside of the air intake system. This enables the ambient pressure to be determined in a particularly simple and reliable manner by means of the differential pressure sensor. Furthermore, determining the ambient pressure in this way has the advantage that it is also possible to determine the ambient pressure during a supercharged operating state of the internal combustion engine, the supercharged operating state of the internal combustion engine being characterized in that the charge pressure is higher than the ambient pressure. The ambient pressure constitutes an important parameter for operating the internal combustion engine because typically it has an effect on the operating characteristics and exhaust gas emissions of the internal combustion engine. Actuators for operating the internal combustion engine are controlled as a function of the ambient pressure.

In a further embodiment the charge pressure is determined and the ambient pressure is determined as a function of the charge pressure. Since the differential pressure is made available by means of the differential pressure sensor, the ambient pressure can be determined particularly easily by means of the determined charge pressure as a further parameter.

In another embodiment an air intake pipe pressure that prevails downstream of the throttle valve and upstream of the gas inlet valve is determined and the charge pressure is determined as a function of the air intake pipe pressure. Since the charge pressure is determined as a function of the determined air intake pipe pressure, a separate charge pressure sensor is preferably not required.

In a further embodiment a degree of opening of the throttle valve is determined. The determined degree of opening of the throttle valve is compared with a predefined degree of opening of a characteristic throttle valve opening. The characteristic throttle valve opening is characterized in that at a degree of opening of the throttle valve which is greater than or equal to the degree of opening of the characteristic throttle valve opening, a drop in pressure across the throttle valve remains essentially constant. After the predefined degree of opening of the characteristic throttle valve opening has been reached, the drop in pressure across the throttle valve is determined, which drop in pressure is associated with a degree of opening of the throttle valve which is greater than or equal to the characteristic throttle valve opening. When the degree of opening of the characteristic throttle valve opening is reached, the charge pressure is determined as a function of the determined drop in pressure. The charge pressure is the pressure that prevails downstream of the compressor and upstream of the throttle valve. If, for example, the air intake pipe pressure that prevails downstream of the throttle valve and upstream of the gas inlet valve is predefined, then the charge pressure can be determined particularly easily as a function of the determined drop in pressure across the throttle valve when the characteristic throttle valve opening is reached. Typically, the drop in pressure across the throttle valve at a characteristic throttle valve opening is associated with pipe friction due to the compressed mass air flow through the throttle valve. The characteristic throttle valve opening is dependent on the rotational speed of the internal combustion engine, i.e. at a predefined rotational speed of the internal combustion engine the current degree of opening of the throttle valve is compared with the degree of opening of the characteristic throttle valve opening associated with the current rotational speed. The drop in pressure of the respective degree of opening of the characteristic throttle valve opening is preferably determined on a reference internal combustion engine at a predefined rotational speed and after having been determined is stored. At a predefined rotational speed of the internal combustion engine the respective drop in pressure when the respective degree of opening of the characteristic throttle valve opening is present is therefore available particularly quickly.

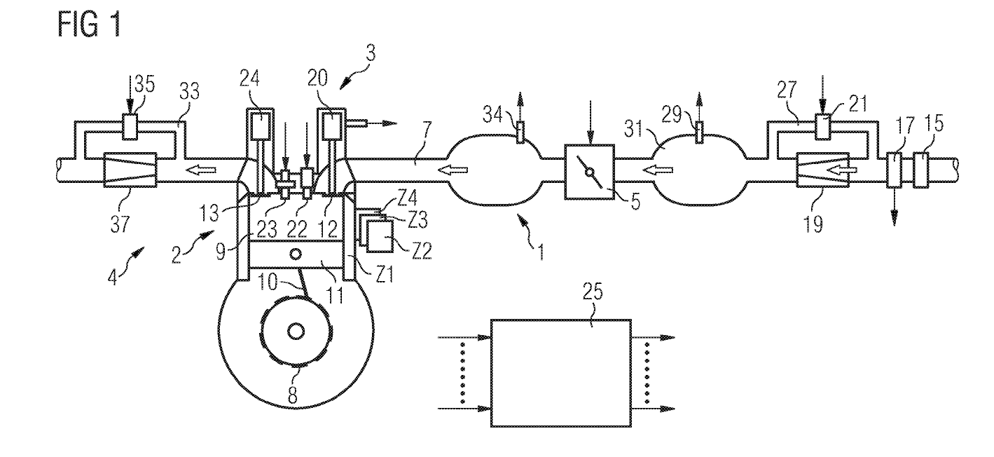

An internal combustion engine (FIG. 1) comprises an air intake system 1, an engine block 2, a cylinder head 3 and an exhaust gas system 4. The air intake system 1 preferably comprises a compressor 19, a charge air cooler 31, a throttle valve 5 and an air intake pipe 7 that is routed toward a cylinder Z1-Z4 via an intake port into a combustion chamber 9 of the engine block 2. Disposed in parallel with the compressor 19 is a first bypass line 27 with which a first bypass valve 21 is associated. The engine block 2 comprises a crankshaft 8 which is coupled to the piston 11 of the cylinder Z1-Z4 via a connecting rod 10. The internal combustion engine is preferably a fill-controlled internal combustion engine and is preferably disposed in a motor vehicle.

The cylinder head 3 comprises a valve actuating mechanism having at least one gas inlet valve 12, at least one gas outlet valve 13 and valve trains 20, 24. The cylinder head 3 also comprises an injection valve 22 and a spark plug 23. Alternatively the injection valve 22 can also be disposed in the air intake pipe 7.

The exhaust gas system 4 comprises a turbine 37 which is mechanically coupled to the compressor 19. Preferably the compressor 19 and the turbine 37 together form a turbocharger of the internal combustion engine. Disposed in parallel with the turbine 37 is a second bypass line 33 which comprises a second bypass valve 35.

Aspirated air flows through an air filter 15 and through a mass air flow meter 17 that is disposed downstream of the air filter 15 into the compressor 19 of the internal combustion engine, said compressor being disposed downstream of the mass air flow meter 17. The first bypass valve 21 of the bypass line 27 is typically closed and is opened only when predefined load cycle changes occur in the internal combustion engine, such as e.g. a load cycle change from a supercharged into a non-supercharged (naturally aspirated) operating state of the internal combustion engine. The supercharged operating state is preferably characterized in that a charge pressure PUT that prevails downstream of the compressor 19 and upstream of the throttle valve 5 is higher than an ambient pressure AMP that prevails outside of the air intake system 1. The air compressed by means of the compressor 19 flows via the charge air cooler 31 which is disposed downstream of the compressor 19 and upstream of the throttle valve 5 and is embodied for the purpose of cooling the compressed air to the throttle valve 5 and thereafter downstream via the air intake pipe 7, which is disposed downstream of the throttle valve 5, and via the gas inlet valve 12 into the combustion chamber 9 of the cylinder Z1-Z4. After a predefined quantity of fuel has been supplied by means of the injection valve 22 and a compression has been effected by means of the piston 11 of the cylinder Z1-Z4, the air/fuel mixture is ignited by means of the spark plug 23. The exhaust gas resulting from the combustion of the air/fuel mixture is discharged via the gas outlet valve 13 and fed to the exhaust gas system 4, where it is supplied to a catalytic converter, for example, by means of the turbine 37. In this case the second bypass valve 35 can be actuated in such a way that part of the exhaust gas is routed past the turbine 37, thereby controlling the rotational speed of the turbine 37 and the compressor 19, which is mechanically coupled to the turbine 37.

A control unit 25 is provided associated with which are sensors that register different measured variables and in each case determine the value of the measured variable. The control unit 25 can also be described as a device for operating the internal combustion engine.

The charge air cooler 31 preferably has a differential pressure sensor 29. The differential pressure sensor 29 is embodied for the purpose of measuring a differential pressure PUT_AMP_DIFₘₑₛ between the charge pressure PUT that prevails downstream of the compressor 19 and upstream of the throttle valve 5 and the ambient pressure AMP that prevails outside of the air intake system 1. Associated with the air intake pipe 7, which is disposed downstream of the throttle valve 5, is an air intake pipe pressure sensor 34 which is embodied for the purpose of measuring an air intake pipe pressure MAP.

The ambient pressure AMP is used in the control unit 25 for the purpose of modeling the operating behavior of the internal combustion engine and in the event of fluctuations in ambient pressure for adjusting an activation of the throttle valve or further actuators of the internal combustion engine, such as e.g. injection valves 22 or spark plugs 23 or bypass valves 21 and/or 35, in accordance with the fluctuations in ambient pressure. Accordingly, knowledge of the ambient pressure AMP is preferably required e.g. for reliable control or adjustment of the rotational speed of the turbine 37 and the compressor 19.

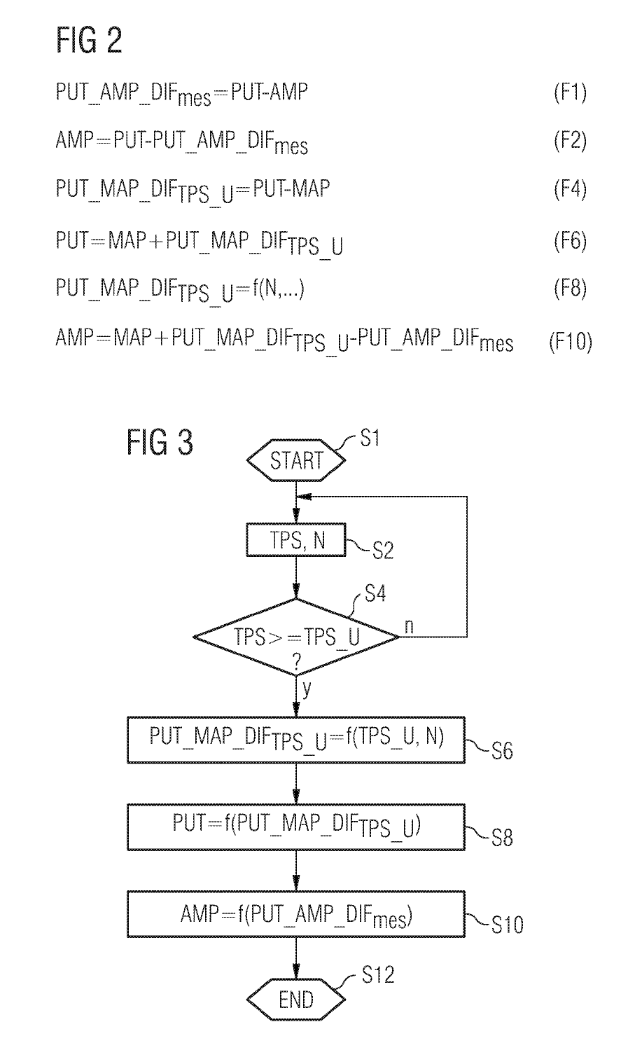

The way in which the ambient pressure AMP is determined is explained in more detail with reference to FIG. 2. Equation F1 represents the differential pressure PUT_AMP_DIFₘₑₛ which is measured by means of the differential pressure sensor 29. The differential pressure PUT_AMP_DIFₘₑₛ is determined from the difference between the charge pressure PUT that prevails downstream of the compressor 19 and upstream of the throttle valve 5 and the ambient pressure AMP that prevails outside of the air intake system 1. Since by preference the differential pressure sensor 29 is not embodied as an absolute pressure sensor, preferably the charge pressure PUT and the ambient pressure AMP cannot be measured individually by means of the differential pressure sensor 29.

According to an equation F2, the ambient pressure AMP is obtained computationally by corresponding transposition of equation F1. According to equation F2, the ambient pressure AMP can be determined as a function of the charge pressure PUT.

Every rotational speed of the internal combustion engine is associated with what is termed a characteristic throttle valve opening TPS_U. The characteristic throttle valve opening TPS_U is typically associated with a predefined drop in pressure PUT_MAP_DIF_{TPS}_{_{—}}_{U} of the mass air flow across the throttle valve 5. Said predefined drop in pressure PUT_MAP_DIF_{TPS}_{_{—}}_{U} across the throttle valve 5 does not decrease any further at a degree of opening of the throttle valve 5 which is greater than or equal to the degree of opening of the characteristic throttle valve opening TPS_U, and consequently can be described as essentially constant. Each rotational speed of the internal combustion engine is therefore associated with a predefined drop in pressure PUT_MAP_DIF_{TPS}_{_{—}}_{U} in each case (equation F8). Preferably the respective predefined drop in pressure PUT MAP DIF_{TPS}_{_{—}}_{U} is determined with the aid of a reference internal combustion engine at a predefined rotational speed and stored in a memory of the control unit 25. If a degree of opening of the throttle valve 5 is detected at a predefined rotational speed of the internal combustion engine, e.g. by means of a throttle valve position sensor, and is greater than or equal to the degree of opening of the characteristic throttle valve opening TPS_U associated with the rotational speed, then the value of the predefined drop in pressure PUT_MAP_DIF_{TPS}_{_{—}}_{U} can be made available on the basis of the data stored in the memory of the control unit 25, as a function of the rotational speed and the characteristic throttle valve opening TPS_U. Typically, the predefined drop in pressure PUT_MAP_DIF_{TPS}_{_{—}}_{U} at the characteristic throttle valve opening TPS_U results from pipe friction due to the mass air flow through the throttle valve 5. The determined drop in pressure PUT_MAP_DIF_{TPS}_{_{—}}_{U} across the throttle valve 5 can also be determined in the supercharged operating state of the internal combustion engine.

According to an equation F4, a drop in pressure across the throttle valve 5 is obtained from the difference between the charge pressure PUT and the air intake pipe pressure MAP. The air intake pipe pressure MAP can preferably be determined by means of the air intake pipe pressure sensor 34.

Alternatively, the air intake pipe pressure MAP can also be determined computationally with the aid of an air intake pipe filling model as a function of the throttle valve opening, the rotational speed of the internal combustion engine and possibly further measured variables.

Since the drop in pressure PUT_MAP_DIF_{TPS}_{_{—}}_{U} across the throttle valve 5 at a degree of opening which is greater than or equal to the degree of opening of the characteristic throttle valve opening TPS_U and at a predefined rotational speed of the internal combustion engine is already predefined, the charge pressure PUT can also be determined in the supercharged operating state of the internal combustion engine with the aid of an equation F6 following corresponding transposition of equation F4.

The charge pressure PUT is thus yielded as a function of already predefined variables, such as the predefined drop in pressure PUT_MAP_DIF_{TPS}_{_{—}}_{U} across the throttle valve 5 at the characteristic throttle valve opening TPS_U, the air intake pipe pressure MAP measured by means of the air intake pipe pressure sensor 34, and the differential pressure PUT_AMP_DIFₘₑₛ measured by means of the differential pressure sensor 29. The ambient pressure AMP can therefore be determined particularly easily and reliably with the aid of an equation F10.

Alternatively, the charge pressure at a predefined ambient pressure can also be determined particularly easily and reliably by means of the differential pressure sensor 29, such as e.g. after the described determining of the ambient pressure AMP, in particular when an additional ambient pressure sensor is disposed downstream of the compressor 19 and upstream of the throttle valve 5. Preferably the ambient pressure measured by means of the additional ambient pressure sensor can also be used to validate the determined ambient pressure for plausibility by means of a comparison with the measured ambient pressure. Furthermore, the charge pressure can be determined as a function of an ambient pressure measured by means of the ambient pressure sensor and by means of a comparison with the determined charge pressure that was determined with the aid of the characteristic throttle valve opening TPS_U.

As a device for operating the internal combustion engine the control unit 25 is preferably embodied for the purpose of executing a program which is explained in more detail with reference to FIG. 3.

The program is started at a step S1. The degree of opening of the current throttle valve opening TPS and the current rotational speed N of the internal combustion engine are measured at a step S2. The degree of opening of the characteristic throttle valve opening TPS_U is determined as a function of the measured rotational speed N of the internal combustion engine. At a step S4, the measured degree of opening of the throttle valve opening TPS is compared with the determined degree of opening of the characteristic throttle valve opening TPS_U. If the current degree of opening of the throttle valve opening TPS is less than that of the characteristic throttle valve opening TPS_U, the current rotational speed N and the current degree of opening of the throttle valve opening TPS are measured again. If the current degree of opening of the throttle valve opening TPS is greater than or equal to the degree of opening of the characteristic throttle valve opening TPS_U, the drop in pressure PUT_MAP_DIF_{TPS}_{_{—}}_{U} across the throttle valve 5 is determined at a step S6 as a function of the rotational speed N and the determined degree of opening of the characteristic throttle valve opening TPS_U. The drop in pressure PUT_MAP_DIF_{TPS}_{_{—}}_{U} across the throttle valve 5 is preferably stored in the control unit 25. At a step S8, the charge pressure PUT is thereupon determined as a function of the air intake pipe pressure MAP, which preferably can be measured by means of the air intake pipe pressure sensor 34, and the determined drop in pressure PUT_MAP_DIF_{TPS}_{_{—}}_{U} across the throttle valve 5. At a step S10, the ambient pressure AMP is determined as a function of the charge pressure PUT and the differential pressure PUT_AMP_DIFₘₑₛ measured by means of the differential pressure sensor 29. The program is terminated at a step S12. Alternatively, however, the program can also be restarted.

What is claimed is:

1. An internal combustion engine comprising
an air intake system which comprises an air intake pipe and communicates with a combustion chamber of a cylinder of the internal combustion engine as a function of a switch position of a gas inlet valve,
a compressor which is disposed in the air intake system and is operable to compress a mass air flow,
a throttle valve which is disposed in the air intake system downstream of the compressor and by means of which the compressed mass air flow of the compressor into the air intake pipe can be throttled,
a differential pressure sensor which is disposed in the air intake system and is operable to measure a differential pressure between a charge pressure that prevails downstream of the compressor and upstream of the throttle valve and an ambient pressure that prevails outside of the air intake system.

2. The internal combustion engine according to claim 1, further comprising an ambient pressure sensor which is operable to measure the ambient pressure.

3. A method for operating an internal combustion engine, comprising:
determining an ambient pressure as a function of a measured differential pressure between a charge pressure that prevails downstream of a compressor and upstream of a throttle valve and an ambient pressure that prevails outside of an air intake system.

4. The method according to claim 3, wherein the charge pressure is determined and the ambient pressure is determined as a function of the charge pressure.

5. The method according to claim 4, wherein an air intake pipe pressure that prevails downstream of the throttle valve and upstream of the gas inlet valve is determined and the charge pressure is determined as a function of the air intake pipe pressure.

6. The method according to claim 4, wherein
a degree of opening of the throttle valve is determined,
wherein the determined degree of opening of the throttle valve is compared with a predefined degree of opening of a characteristic throttle valve opening, the characteristic throttle valve opening being characterized in that at a degree of opening of the throttle valve which is greater than or equal to the degree of opening of the characteristic throttle valve opening a drop in pressure across the throttle valve remains essentially constant,
after the predefined degree of opening of the characteristic throttle valve opening has been reached, the drop in pressure across the throttle valve, which drop in pressure is associated with a degree of opening of the throttle valve which is greater than or equal to the characteristic throttle valve opening, is determined,
when the degree of opening of the characteristic throttle valve opening is reached, the charge pressure is determined as a function of the determined drop in pressure.

7. A device for operating an internal combustion engine, wherein the device is operable to determine an ambient pressure as a function of a measured differential pressure between a charge pressure that prevails downstream of a compressor and upstream of a throttle valve and the ambient pressure that prevails outside of an air intake system.

8. The device according to claim 7, wherein the internal combustion engine comprises
the air intake system which comprises an air intake pipe and communicates with a combustion chamber of a cylinder of the internal combustion engine as a function of a switch position of a gas inlet valve,
the compressor which is disposed in the air intake system and is operable to compress a mass air flow,
the throttle valve which is disposed in the air intake system downstream of the compressor and by means of which the compressed mass air flow of the compressor into the air intake pipe can be throttled, and
a differential pressure sensor which is disposed in the air intake system and is operable to measure the differential pressure.

9. The device according to claim 8, further comprising an ambient pressure sensor which is operable to measure the ambient pressure.

10. The method according to claim 3, wherein the internal combustion engine comprises
the air intake system which comprises an air intake pipe and communicates with a combustion chamber of a cylinder of the internal combustion engine as a function of a switch position of a gas inlet valve,
the compressor which is disposed in the air intake system and is operable to compress a mass air flow,
the throttle valve which is disposed in the air intake system downstream of the compressor and by means of which the compressed mass air flow of the compressor into the air intake pipe can be throttled, and
a differential pressure sensor which is disposed in the air intake system and is operable to measure the differential pressure.

11. The method according to claim 10, wherein the internal combustion engine further comprises an ambient pressure sensor which is operable to measure the ambient pressure.
